(19) United States
(12) Patent Application Publication
(10) Pub. No.: US 2025/0251315 A1
(43) Pub. Date: Aug. 7, 2025

(54) AUXILIARY DEVICE FOR FREEZING MICROTOME

(71) Applicant: SHENZHEN INSTITUTES OF ADVANCED TECHNOLOGY CHINESE ACADEMY OF SCIENCES, SHENZHEN (CN)

(72) Inventors: TIANWEN HUANG, SHENZHEN (CN); JIN KE, SHENZHEN (CN); SUNWOOK MOON, SHENZHEN (CN)

(21) Appl. No.: 19/189,202

(22) Filed: Apr. 24, 2025

Related U.S. Application Data
(63) Continuation of application No. PCT/CN2022/128515, filed on Oct. 31, 2022.

(51) Int. Cl. G01N 1/06

(52) U.S. Cl. CPC G01N 1/06; G01N 2001/061; G01N 2001/068

(57) ABSTRACT

The present disclosure relates to an auxiliary device for freezing microtome. The auxiliary device includes a sample head adjustment structure configured for adjusting an angle of a sample head of the freezing microtome, as well as an illumination and amplification system configured for illuminating and magnification a sample placed on the sample head. The sample head adjustment structure utilizes a micrometer knob with an angle indicator to adjust an angle of the sample head, a desired adjusted angle can be observed intuitively, thus solving a problem of a sample angle being difficult to adjust. The structure of the sample during slicing can be observed in real time by using the illumination and amplification system, and the improvement of slicing efficiency and quality are facilitated.

### CROSS-REFERENCE TO RELATED APPLICATIONS

This application is a continuation of co-pending International Patent Application Number PCT/CN2022/128515, filed on Oct. 31, 2022, the disclosure of which is incorporated herein by reference in its entirety.

### TECHNICAL FIELD

This application relates to technical fields of medical equipments, and in particular to an auxiliary device for freezing microtome.

### BACKGROUND

The freezing microtome is a medical equipment mainly used for rapid pathological diagnosis of fresh tissues during surgery, to determine the nature of lesions, the presence or absence of metastasis of tumors, and the presence or absence of lesions on the excision stump and to provide a reliable basis for surgical treatment. In addition, frozen sections can also be used for basic scientific research, mainly used for rapid slicing of neural tissues (animal brain, spinal cord, viscera, etc.), for analyzing various molecules, proteins, cell expression in the sample. Both clinical research and basic science research need to get high-quality section samples in order to ensure high-quality pictures, which can not only improve the reliability of the experimental results, but also improve the aesthetics of the readers.

The current microtome mainly consists of a host computer (including freezing cabinet, sample head, quick-freezing platform and other devices), knife racks and blades, etc., and the current freezing microtome has the following shortcomings: firstly, in the fine-tuning aspect of the sample head, a current construction of an adjustment structure is relatively rough, a sample angle can not be observed intuitively, and the adjustment structure of the sample head has rust, jamming and other problems, which greatly increase the difficulty of adjusting the sample angle; secondly, in the process of sample fine-tuning, the adjusted sample angle can only be estimated by hand, which is difficult and inefficient for novice practitioners; thirdly, there are some deficiencies in the lighting design, a lighting angle is not in a same plane as the sample angle, resulting in the sample display being darker and the fine structure of the sample cannot be observed intuitively. In other words, the current freezing microtome has obvious deficiencies in the fineness and clarity of sample adjustment. Therefore, it is of great significance to improve the sample head structure based on the existing microtome to improve the fineness and clarity of sample adjustment for the quality of sectioned samples.

### SUMMARY

One purpose of the present disclosure is to provide an auxiliary device for freezing microtome, the auxiliary device being capable of fine-tuning and displaying an angle of a sample head during a slicing process, and being capable of illuminating and magnifying a sample so as to facilitate visualization of a fine structure of the sample, which is conducive to improve the quality and efficiency of the slicing of the sample.

The present disclosure provides an auxiliary device for freezing microtome, including a sample head adjustment structure and an illumination and magnification system.

The sample head adjustment structure can be located on a sample head base, for adjusting an angle of a sample head of the freezing microtome. The sample head adjustment structure can include at least one fine-adjustment assembly. The fine-adjustment assembly can include a micrometer knob, a transmission mechanism driven by the micrometer knob and a linkage member located on the sample head base and coupled to the transmission mechanism. The fine-adjustment assembly can be configured to drive the transmission mechanism by rotating the micrometer knob to drive a swing of the sample head base, thereby realizing adjustment of an angle of the sample head mounted on the sample head base.

The illumination and magnification system can be mounted on an internal panel of the freezing microtome and can be configured to illuminate and magnify a sample placed on the sample head.

In at least some embodiments of the present disclosure, the transmission mechanism can be any one or more combinations of a gear assembly, a hinge, a turbine worm, a belt.

In at least some embodiments of the present disclosure, the transmission mechanism can be a gear assembly, the gear assembly can include a circular gear fixedly coupled to the micrometer knob and a horizontal gear linked to the circular gear and coupled to the linkage member.

In at least some embodiments of the present disclosure, the transmission mechanism can further include a first connection rod coupled to the circular gear, a second connection rod coupled to the micrometer knob and a connection ring coupled between the first connection rod and the second connection rod.

In at least some embodiments of the present disclosure, the linkage member may be a metal cap, the metal cap can couple the horizontal gear and the sample head base, the micrometer knob can be provided with an angle indicator for displaying an adjusted angle of the micrometer knob.

In at least some embodiments of the present disclosure, the micrometer knob can have an adjustment angle of 1° at a time and an angle adjustment range of 0 to 45°.

In at least some embodiments of the present disclosure, the quantity of the fine-adjustment assemblies can be two, and the two fine-adjustment assemblies can be disposed in two vertical directions of the sample head base for adjusting, respectively, an angle of a main body of the sample head in two vertical orientations.

In at least some embodiments of the present disclosure, the illumination and magnification system can include a mounting member detachably mounted on an internal panel of the freezing microtome, a first support rod coupled to the mounting member, a second support rod rotatably coupled to the first support rod, and an illumination and magnification assembly rotatably coupled to the second support rod. The illumination and magnification assembly can include a fixed base rotatably coupled to the second support rod, a magnifying glass set in a center of the fixed base and a plurality of illumination lamps disposed on the fixed base and spaced around the magnifying glass.

In at least some embodiments of the present disclosure, the mounting member can be mounted to the internal panel of the freezing microtome by screws or magnetic suction pads.

In at least some embodiments of the present disclosure, the first support rod and the second support rod can be coupled by a first nut, the second support rod and fixed base can be coupled by a second nut, the illumination lamps can be LED lamps, and the fixed base can be provided with a charging port for charging the LED lamps.

The present disclosure provides an auxiliary device for freezing microtome, optimizing the structure of the freezing microtome from two aspects based on the existing freezing microtome. On the one hand, the fine-adjustment assembly can be provided to freely fine-adjust the angle of the sample head, and on the other hand, the illumination and magnification system can be provided to illuminate and magnify the sample mounted on the sample head, so that by using the auxiliary device for the freezing microtome of the present disclosure, the angle of the sample head can be fine-adjusted and displayed during the slicing process, and at the same time, the brightness of the sample can be increased and the fine structure of the sample can be magnified, which is conducive to improve the symmetry of the sample slicing and slicing efficiency.

The fine-adjustment assembly of the present disclosure can adjust the angle of the sample head by rotating the micrometer knob, and the micrometer knob is provided with an angle indicator for displaying the adjusted angle in real time, so that by using the auxiliary device for freezing microtome of the present disclosure, the sample angle can be finely adjusted, and the adjustment operation is convenient and simple, and the efficiency is high.

The illumination and magnification system of the present disclosure, by the two rotatable support rods being coupled to the illumination and magnification assembly, the position of the illumination and magnification assembly can be adjusted according to the demand, which can make the lighting angle and the sample angle in a same plane, and improve the brightness of the sample. Moreover, the illumination and magnification assembly of the present disclosure can be also provided with the magnifying glass, so that the fine structure of the sample can be observed intuitively, thereby assisting the operator in slicing the sample more accurately, which is conducive to improve the quality of slicing.

The purpose and advantages of the present disclosure will be further clarified through understanding the following description and accompanying drawings.

### BRIEF DESCRIPTION OF DRAWINGS

FIG. 1 illustrates a schematic structural view of a fine-adjustment assembly of an auxiliary device for freezing microtome of the present disclosure mounted on a sample head.

FIG. 2 illustrates an exploded view of the fine-adjustment assembly of the present disclosure.

FIG. 3 illustrates a schematic structural view of a circular gear of the fine-adjustment assembly of the present disclosure.

FIG. 4 illustrates a schematic structural view of a horizontal gear of the fine-adjustment assembly of the present disclosure.

FIG. 5 illustrates a schematic structural view of an illumination and magnification system of the auxiliary device for freezing microtome of the present disclosure.

The description of reference signs:
10-sample head adjustment structure; 11-fine-adjustment assembly; 111-micrometer knob; 1111-angle indicator; 112-transmission mechanism; 113-linkage member; 1121-circular gear; 1122-horizontal gear; 1123-first connection rod; 1124-second connection rod; 1125-connection ring; 20-illumination and magnification system; 21-mounting member; 22-first support rod; 23-second support rod; 24-illumination and magnification assembly; 241-fixed base; 242-magnifying glass; 243-illumination lamp; 244-charging port; 25-first nut; 26-second nut; 31-sample head base; 32-sample head; 33-internal panel.

### DESCRIPTION OF EMBODIMENTS

The following description is used to expose the present disclosure so that a person skilled in the art can realize the application. The preferred embodiments in the following description are intended as examples only, and other obvious variations can be thought of by those skilled in the art. The basic principles of the present disclosure defined in the following description may be applied to other implementation solutions, transformation solutions, improvement solutions, equivalence solutions and other technical solutions that do not depart from the spirit and scope of the present disclosure.

It should be understood by those skilled in the art that, in the present disclosure, the terms ‘vertical orientation’, ‘orthogonal orientation’, ‘up’, ‘down’, ‘front’, ‘back’, ‘left’, ‘right’, ‘vertical’, “horizontal”, “top”, “bottom” ‘inside’, ‘outside’ and the like indicate orientations or positional relationships based on those shown in the accompanying drawings, which are only for the purpose of facilitating the description of the present disclosure and simplifying the description, and are not indicative of or suggestive of the necessity for the device or element referred to be of a particular orientation, to be constructed and operated in a particular orientation, and therefore the above terms are not to be construed as a limitation of the present disclosure.

It is to be understood that the term ‘one’ is to be understood as ‘at least one’ or ‘one or more’, i.e., in one embodiment, the number of one element may be one, and in another embodiment, the number of the element may be more than one, and the term ‘one’ is not to be understood as a limitation on the number.

In the description of the present disclosure, it is to be noted that, unless otherwise expressly specified and limited, the terms ‘mounted’, ‘coupled with each other’, ‘coupled’ are to be understood in a broad sense, e.g., as a fixed connection or as a detachable connection, or an integral connection; it may be a mechanical connection, an electrical connection or a connection that can communicate with each other; it may be a direct connection or an indirect connection through an intermediate medium; it may be a connection within the two elements or an interaction between the two elements. For those of ordinary skill in the art, the specific meanings of the above terms in the present disclosure may be understood on a case-by-case basis.

In view of a technical problem of the existing freezing microtome, there are obvious deficiencies in the fineness and clarity of sample adjustment, the present disclosure provides an auxiliary device for freezing microtome, and the present disclosure optimizes the structure of the freezing microtome from two aspects, on the one hand, a fine-adjustment assembly is provided to freely fine-adjust an angle of a sample head, and on the other hand, an illumination and magnification system is provided to illuminate and magnify a sample mounted on the sample head, so that by using the auxiliary device for freezing microtome of the present disclosure, the angle of the sample head can be finely adjusted during the slicing process, and at the same time, the brightness of the sample can be increased and the fine structure of the sample can be magnified, which is conducive to improve the symmetry of the sample slicing and slicing efficiency.

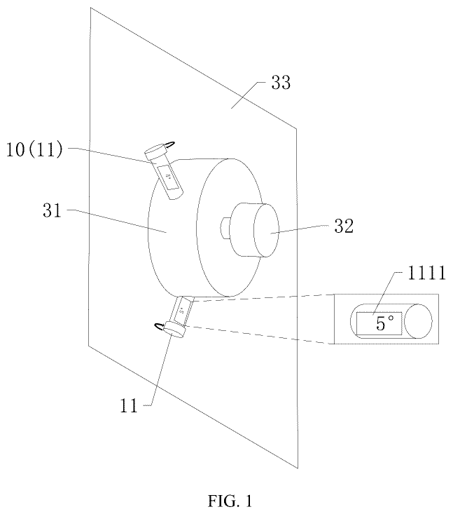

As shown in FIGS. 1 to 5, the specific structure of the auxiliary device for freezing microtome according to a preferred embodiment of the present disclosure is elucidated.

In detail, the auxiliary device for freezing microtome can include a sample head adjustment structure 10 and an illumination and magnification system 20. The sample head adjustment structure 10 can be located on a sample head base 31 of the freezing microtome, and can be configured to adjust an angle of a sample head of the freezing microtome. The illumination and magnification system 20 can be mounted on an internal panel 33 of the freezing microtome and can be configured to illuminate and magnify a sample placed on the sample head 32.

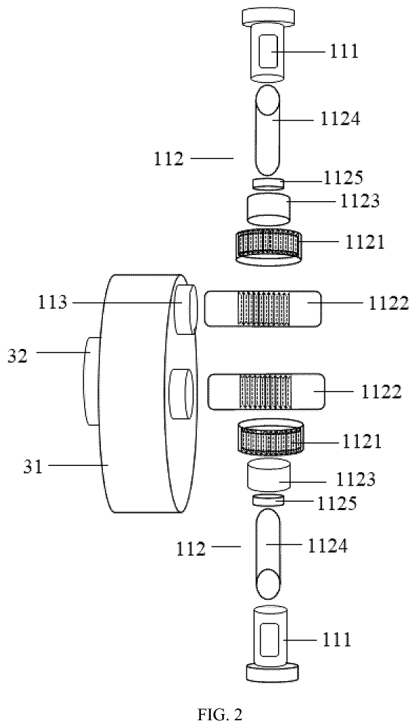

More detail, as shown in FIG. 2, the sample head adjustment structure 10 can include at least one fine-adjustment assembly 11. The fine-adjustment assembly 11 can include a micrometer knob 111, a transmission mechanism 112 driven by the micrometer knob 111 and a linkage member 113 located on the sample head base 31 and coupled to the transmission mechanism 112. The fine-adjustment assembly 11 can be configured to drive the transmission mechanism 112 by rotating the micrometer knob 111 to drive a swing of the sample head base 31, thereby realizing adjustment of an angle of a sample head 32 mounted on the sample head base 31.

Optionally, the transmission mechanism 112 can be any one or more combinations of a gear assembly, a hinge, a turbine worm, a belt.

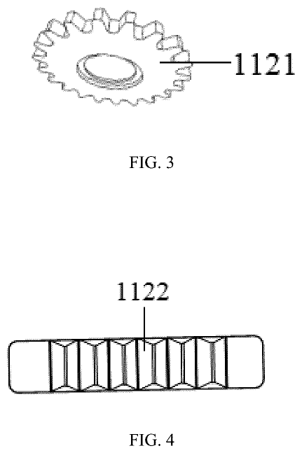

Specifically, in at least one embodiment of the present disclosure, the transmission mechanism 112 can adopt a gear assembly to realize transmission. The gear assembly can include a circular gear 1121 fixedly coupled to the micrometer knob 111 and a horizontal gear 1122 linked to the circular gear 1121 and coupled to the linkage member 113, where the detail structure of the circular gear 1121 is shown as FIG. 3, the detail structure of the horizontal gear 1122 is shown as FIG. 4.

It is worth mentioning that the transmission mechanism 112 can further include a first connection rod 1123 coupled to the circular gear 1121, a second connection rod 1124 coupled to the micrometer knob 111 and a connection ring 1125 coupled between the first connection rod 1123 and the second connection rod 1124.

In detail, the linkage member 113 may be a metal cap, the metal cap can couple the horizontal gear 1122 and the sample head base 31, the micrometer knob 111 can be provided with an angle indicator 1111 for displaying an adjusted angle of the micrometer knob 111.

In at least one embodiment of the present disclosure, the micrometer knob 111 can have an adjustment angle of 1° at a time and an angle adjustment range of 0 to 45°. In other embodiments of the present disclosure, the micrometer knob 111 can have an adjustment angle of other values, such as 3°, 5°, 9° or the like, without limited herein.

It can be understood that the metal cap can be configured to couple the horizontal gear 1122 to the sample head base 31, the circular gear 1121 can be driven to rotate by rotation of the micrometer knob 111, the circular gear 1121 can be engaged with the horizontal gear 1122, the circular gear 1121 can cause the horizontal gear 1122 to move from left to right as it rotates, thereby causing the sample head base 31 to tilt upwardly or downwardly, that is to say, causing the sample head base 31 to oscillate, thereby adjusting the angle of the sample head mounted on the sample head base 31.

In at least one embodiment of the present disclosure, the quantity of the fine-adjustment assemblies 11 can be two, and the two fine-adjustment assemblies 11 can be disposed in two vertical directions of the sample head base 31 for adjusting, respectively, an angle of a main body of the sample head 32 in two vertical orientations.

For example, the fine-adjustment assembly 11 can include a first fine-adjustment assembly and a second fine-adjustment assembly. The first fine-adjustment assembly can be configured to drive the same head base 31 oscillate up and down so as to adjust the angle of the sample head 32 in an up-down direction. The second fine-adjustment assembly can be configured to drive the sample head base 31 to oscillate left and right so as to adjust the angle of the sample head 32 in the left-right direction. By using the two fine-adjustment assemblies, it is possible to adjust the angle of the sample head 32 in four directions: up and down, left and right.

It can be understood that since the angle of the sample head can be adjusted by rotating the micrometer knob 111, and the micrometer knob 111 is provided with an angle indicator 1111, which can be capable of displaying the adjusted angle in real time, and each rotation corresponds to a specific angle (e.g., a single rotation corresponds to 1°). Therefore, by using the auxiliary device of the freezing microtome of the present disclosure, the sample angle can be finely adjusted, and the adjustment operation is convenient, simple and highly efficient.

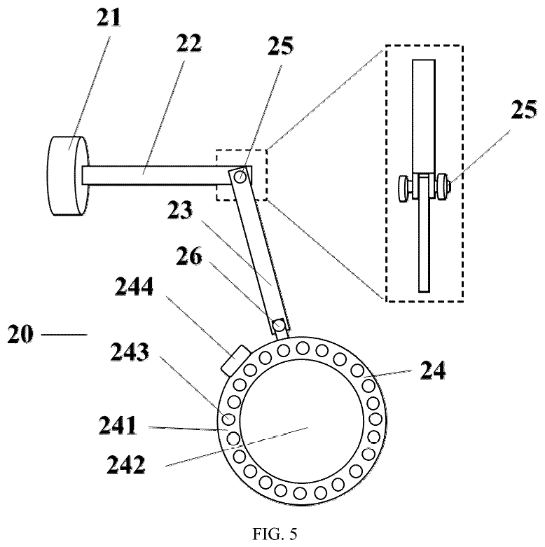

Furthermore, as shown in FIG. 5, the illumination and magnification system 20 can include a mounting member 21 detachably mounted on an internal panel 33 of the freezing microtome, a first support rod 22 coupled to the mounting member 21, a second support rod 23 rotatably coupled to the first support rod 22, and an illumination and magnification assembly 24 rotatably coupled to the second support rod 23. The illumination and magnification assembly 24 can include a fixed base 241 rotatably coupled to the second support rod 23, a magnifying glass 242 set in a center of the fixed base 241 and a plurality of illumination lamps 243 disposed on the fixed base 241 and spaced around the magnifying glass 242.

It can be understood that the present disclosure sets the illumination and magnification system 20 to be detachably mounted to the internal panel 33 of the freezing microtome, so as to be able to adjust the mounting position of the illumination and magnification system 20 according to actual needs, thereby facilitating the adjustment of the illumination and magnification angle of the illumination and magnification system 20, to ensure the illumination brightness and accurate magnification position of the sample, and facilitating the use by the operator.

Optionally, the mounting member 21 can be detachably mounted to the internal panel 33 of the freezing microtome by screws or magnetic suction pads. In this embodiment, the mounting member 21 can be a magnetic suction pad.

It should be understood that the mounting member 21 may also be mounted to the internal panel 33 of the freezing microtome by using other removable structures, and this application does not limit this.

It is worth mentioning that the first support rod 22 and the second support rod 23 can be coupled by a first nut 25, the second support rod 23 and fixed base 241 can be coupled by a second nut 26, whereby the second support rod 23 can be rotated with respect to the first support rod 22 and the illumination and magnification assembly 24 can be rotated with respect to the second support rod 23, thereby achieving an angle adjustability of the illumination and magnification assembly 24 with respect to the mounting member 21, thus it is easy to adjust the illumination angle and magnification angle of the illumination and magnification assembly 24 according to actual needs.

In at least one embodiment of the present disclosure, the magnifying glass 242 can magnify a fine structure of a small sample, greatly improving the resolution of the naked eye. The magnifying glass 242 can be surrounded by 15 to 20 illumination lamps 243, which can enhance the brightness of the sample and greatly improve the accuracy of naked eye observation. The present disclosure does not limit the quantity of illumination lamps 243

It is also worth mentioning that the fixed base 241 can be a ring-shaped plastic ring for mounting the magnifying glass 242 and the illumination lamps 243. In this embodiment, the illumination lamps 243 can be LED lamps, and in order to facilitate the use, the fixed base 241 can be provided with a charging port 244 for charging the LED lamps, and the charging port 244 can be a USB charging port.

It can be understood that the illumination and magnification system 20 of the present disclosure, by the two rotatable support rods being coupled to the illumination and magnification assembly 24, the position of the illumination and magnification assembly 24 can be adjusted according to the demand, which can make the lighting angle and the sample angle in a same plane, and improve the brightness of the sample. Moreover, the illumination and magnification assembly 24 of the present disclosure can be also provided with the magnifying glass 242, so that the fine structure of the sample can be observed intuitively, thereby assisting the operator in slicing the sample more accurately, which is conducive to improve the quality of slicing.

This application is in two parts, the first part is to optimize the equipment to facilitate the experimenter's fine-adjustment of the symmetry of the sample from the operation point of view, and the second part is to adopt a simple structural design to improve the experimenter's control of the process of sample slicing from the sample identification of view. The two parts are designed to improve the high quality and efficiency of sample slicing. By using the auxiliary device for freezing microtome described in the present disclosure, the experimenter can greatly reduce the time spent on adjusting the symmetry of the sample during the process of sample slicing and further improve the quality of the slicing, and enhance the credibility and accuracy of the experiment.

The present disclosure makes a simple modification on the basis of the original freezing microtome by adding an adjustment knob for sample head with an angle indicator, which can intuitively observe the required adjusted angle, solving the problem of difficulty in adjusting the sample angle. In addition, with the described illumination and magnification system 20, the structure of the sample during slicing can be further observed in real time, and can be adjusted in time if the problem of sample asymmetry occurs. With the present disclosure, during the process of frozen slicing, no matter when a novice or a skilled person, it is possible to avoid to the greatest extent possible the degradation of the quality of the sample due to the problem of the angle of the sample slicing. In addition, the present disclosure improves the resolution of the naked eye observation of smaller samples by using the magnifying glass, which can improve the operator's control of the sample and reduce experimental errors.

The various technical features of the above embodiments can be combined in any way, and all possible combinations of the various technical features of the above embodiments have not been described in order to make the description concise; however, as long as there is no contradiction in the combinations of these technical features, all of them should be considered to be within the scope of the present specification.

The above embodiments only express the preferred embodiments of the present disclosure, which are described in a more specific and detailed manner, but are not to be construed as a limitation of the scope of the patent of the present disclosure. It should be pointed out that, for a person of ordinary skill in the art, a number of deformations and improvements can be made without departing from the conception of the present disclosure, all of which fall within the scope of protection of the present disclosure. Therefore, the scope of protection of the patent application shall be subject to the attached claims.

What is claimed is:

1. An auxiliary device for freezing microtome, wherein comprising
a sample head adjustment structure, wherein the sample head adjustment structure is located on a sample head base of the freezing microtome, for adjusting an angle of a sample head of the freezing microtome; the sample head adjustment structure comprises at least one fine-adjustment assembly, the fine-adjustment assembly comprises a micrometer knob, a transmission mechanism driven by the micrometer knob and a linkage member located on the sample head base and coupled to the transmission mechanism; the fine-adjustment assembly is configured to drive the transmission mechanism by rotating the micrometer knob to drive a swing of the sample head base, thereby realizing adjustment of the angle of the sample head mounted on the sample head base; and,
an illumination and magnification system being mounted to an internal panel of the freezing microtome and being configured to illuminate and magnify a sample placed on the sample head.

2. The auxiliary device for freezing microtome according to claim 1, wherein the transmission mechanism is any one or more combinations of a gear assembly, a hinge, a turbine worm, a belt.

3. The auxiliary device for freezing microtome according to claim 2, wherein the transmission mechanism is a gear assembly, the gear assembly comprises a circular gear fixedly coupled to the micrometer knob and a horizontal gear linked to the circular gear and coupled to the linkage member.

4. The auxiliary device for freezing microtome according to claim 3, wherein the transmission mechanism further comprises a first connection rod coupled to the circular gear, a second connection rod coupled to the micrometer knob and a connection ring coupled between the first connection rod and the second connection rod.

5. The auxiliary device for freezing microtome according to claim 3, wherein the linkage member is a metal cap, the metal cap couples the horizontal gear and the sample head base, the micrometer knob is provided with an angle indicator for displaying an adjusted angle of the micrometer knob.

6. The auxiliary device for freezing microtome according to claim 5, wherein the micrometer knob has an adjustment angle of 1° at a time and an angle adjustment range of 0 to 45°.

7. The auxiliary device for freezing microtome according to claim 1, wherein the quantity of the fine-adjustment assemblies is two, and the two fine-adjustment assemblies are disposed in two vertical directions of the sample head base for adjusting, respectively, an angle of a main body of the sample head in the two vertical orientations.

8. The auxiliary device for freezing microtome according to claim 2, wherein the quantity of the fine-adjustment assemblies is two, and the two fine-adjustment assemblies are disposed in two vertical directions of the sample head base for adjusting, respectively, an angle of a main body of the sample head in the two vertical orientations.

9. The auxiliary device for freezing microtome according to claim 3, wherein the quantity of the fine-adjustment assemblies is two, and the two fine-adjustment assemblies are disposed in two vertical directions of the sample head base for adjusting, respectively, an angle of a main body of the sample head in the two vertical orientations.

10. The auxiliary device for freezing microtome according to claim 4, wherein the quantity of the fine-adjustment assemblies is two, and the two fine-adjustment assemblies are disposed in two vertical directions of the sample head base for adjusting, respectively, an angle of a main body of the sample head in the two vertical orientations.

11. The auxiliary device for freezing microtome according to claim 5, wherein the quantity of the fine-adjustment assemblies is two, and the two fine-adjustment assemblies are disposed in two vertical directions of the sample head base for adjusting, respectively, an angle of a main body of the sample head in the two vertical orientations.

12. The auxiliary device for freezing microtome according to claim 6, wherein the quantity of the fine-adjustment assemblies is two, and the two fine-adjustment assemblies are disposed in two vertical directions of the sample head base for adjusting, respectively, an angle of a main body of the sample head in the two vertical orientations.

13. The auxiliary device for freezing microtome according to claim 1, wherein the illumination and magnification system comprises a mounting member detachably mounted to the internal panel of the freezing microtome, a first support rod coupled to the mounting member, a second support rod rotatably coupled to the first support rod, and an illumination and magnification assembly rotatably coupled to the second support rod; the illumination and magnification assembly comprises a fixed base rotatably coupled to the second support rod, a magnifying glass set in a center of the fixed base and a plurality of illumination lamps disposed on the fixed base and spaced around the magnifying glass.

14. The auxiliary device for freezing microtome according to claim 2, wherein the illumination and magnification system comprises a mounting member detachably mounted to the internal panel of the freezing microtome, a first support rod coupled to the mounting member, a second support rod rotatably coupled to the first support rod, and an illumination and magnification assembly rotatably coupled to the second support rod; the illumination and magnification assembly comprises a fixed base rotatably coupled to the second support rod, a magnifying glass set in a center of the fixed base and a plurality of illumination lamps disposed on the fixed base and spaced around the magnifying glass.

15. The auxiliary device for freezing microtome according to claim 3, wherein the illumination and magnification system comprises a mounting member detachably mounted to the internal panel of the freezing microtome, a first support rod coupled to the mounting member, a second support rod rotatably coupled to the first support rod, and an illumination and magnification assembly rotatably coupled to the second support rod; the illumination and magnification assembly comprises a fixed base rotatably coupled to the second support rod, a magnifying glass set in a center of the fixed base and a plurality of illumination lamps disposed on the fixed base and spaced around the magnifying glass.

16. The auxiliary device for freezing microtome according to claim 4, wherein the illumination and magnification system comprises a mounting member detachably mounted to the internal panel of the freezing microtome, a first support rod coupled to the mounting member, a second support rod rotatably coupled to the first support rod, and an illumination and magnification assembly rotatably coupled to the second support rod; the illumination and magnification assembly comprises a fixed base rotatably coupled to the second support rod, a magnifying glass set in a center of the fixed base and a plurality of illumination lamps disposed on the fixed base and spaced around the magnifying glass.

17. The auxiliary device for freezing microtome according to claim 5, wherein the illumination and magnification system comprises a mounting member detachably mounted to the internal panel of the freezing microtome, a first support rod coupled to the mounting member, a second support rod rotatably coupled to the first support rod, and an illumination and magnification assembly rotatably coupled to the second support rod; the illumination and magnification assembly comprises a fixed base rotatably coupled to the second support rod, a magnifying glass set in a center of the fixed base and a plurality of illumination lamps disposed on the fixed base and spaced around the magnifying glass.

18. The auxiliary device for freezing microtome according to claim 6, wherein the illumination and magnification system comprises a mounting member detachably mounted to the internal panel of the freezing microtome, a first support rod coupled to the mounting member, a second support rod rotatably coupled to the first support rod, and an illumination and magnification assembly rotatably coupled to the second support rod; the illumination and magnification assembly comprises a fixed base rotatably coupled to the second support rod, a magnifying glass set in a center of the fixed base and a plurality of illumination lamps disposed on the fixed base and spaced around the magnifying glass.

19. The auxiliary device for freezing microtome according to claim 13, wherein the mounting member is mounted to the internal panel of the freezing microtome by screws or magnetic suction pads.

20. The auxiliary device for freezing microtome according to claim 13, wherein the first support rod and the second support rod are coupled by a first nut, the second support rod and fixed base are coupled by a second nut, the illumination lamps are LED lamps, and the fixed base is provided with a charging port for charging the LED lamps.
